(19) United States
(12) Patent Application Publication
(10) Pub. No.: US 2016/0357269 A1
(43) Pub. Date: Dec. 8, 2016

(54) BACKLIGHT MODULE AND LIGHTING KEYBOARD USING THE SAME

(71) Applicants: DARFON ELECTRONICS (SUZHOU) CO., LTD., Jiangsu Province (CN); Darfon Electronics Corp., Taoyuan City (TW)

(72) Inventors: Hung-Yu Tai, Taoyuan City (TW); Chia-Yun Yang, Taoyuan City (TW)

(21) Appl. No.: 15/095,226

(22) Filed: Apr. 11, 2016

(30) Foreign Application Priority Data
Jun. 5, 2015 (TW) 104118295
Dec. 18, 2015 (TW) 104142856

(51) Int. Cl. G06F 3/02; F21V 8/00

(52) U.S. Cl. CPC G06F 3/0202; G02B 6/0068; G02B 6/0055; G02B 6/0088

(57) ABSTRACT

A backlight module and a lighting keyboard using the same are provided. The backlight module includes a flexible circuit board, a light-emitting element, a light shielding layer and a light guide plate. The light-emitting element is disposed on the flexible circuit board. The light shielding layer is disposed on the flexible circuit board and surrounds the whole light-emitting element. The light guide plate has a through hole, the light emitting element is located within the through hole, and the light shielding layer is located between the substrate and the light guide layer.

### TECHNICAL FIELD

This application claims the benefits of Taiwan application Serial No. 104118295, filed Jun. 5, 2015, and application serial number 104142856, filed Dec. 18, 2015, the subject matters of which are incorporated herein by reference.

The invention relates in general to a backlight module and a lighting keyboard using the same having a light shielding layer.

### BACKGROUND

Conventional backlight MODULE includes several light-emitting diodes which may emit light laterally for providing keys with illumination. However, the lateral emitting-light is easy to leak from a gap or a space between structures, and it cause problem in leak of light and/or reduction of strength of light.

Thus, how to resolve the problem in leak of light and/or reduction of strength of light is needed.

### SUMMARY

The present invention provides a backlight module and a lighting keyboard, and it may improve the problem in leak of light and/or reduction of strength of light.

According to an embodiment of the invention, a backlight module is provided. The backlight module of a keyboard comprises a flexible circuit board, a light-emitting component, a light shielding layer and a light guiding plate. The light-emitting component is disposed on the flexible circuit board. The light shielding layer is disposed on the flexible circuit board and surrounds the whole light-emitting component. The light guiding plate has a through hole within which the light-emitting component is disposed. The light shielding layer is located between the flexible circuit board and the light guiding plate.

According to another embodiment of the invention, a light-emitting keyboard is provided. The light-emitting keyboard includes a bottom plate, a plurality of keys and a backlight module. The keys are disposed on the bottom plate. The backlight module is disposed under the bottom plate. The backlight module of a keyboard comprises a flexible circuit board, a light-emitting component, a light shielding layer and a light guiding plate. The light-emitting component is disposed on the flexible circuit board. The light shielding layer is disposed on the flexible circuit board and surrounds the whole light-emitting component. The light guiding plate has a through hole within which the light-emitting component is disposed. The light shielding layer is located between the flexible circuit board and the light guiding plate.

According to another embodiment of the invention, a backlight module is provided. The backlight module includes a flexible circuit board, a light-emitting component, a light guiding plate, a reflective layer and a light shielding layer. The light-emitting component is disposed on an upper surface of the flexible circuit board has a light-emitting lateral surface. The light guiding plate is disposed on the flexible circuit board and has a light-incident lateral surface. The reflective layer is disposed on a lower surface of the light guiding plate. The light shielding layer is disposed between the flexible circuit board and the reflective layer and surrounds the whole light-emitting lateral surface. At least a portion of the light-emitting lateral surface is higher than a top surface of the reflective layer, at least a portion of the light-emitting lateral surface is opposite to the light-incident lateral surface, a first light emitted by the light-emitting lateral surface enters the light guiding plate from the light-incident lateral surface, the first light is reflected by the reflective layer back to the light guiding plate when the first light escapes from the lower surface of the light guiding plate, and a second light emitted by the light-emitting lateral surface which does not enter the light guiding plate is absorbed by the light shielding layer.

According to another embodiment of the invention, a backlight module is provided. The backlight module includes a flexible circuit board, a light-emitting component, a light guiding plate, a reflective layer and a light shielding layer. The light-emitting component is disposed on an upper surface of the flexible circuit board has a light-emitting lateral surface. The light-emitting component is disposed on an upper surface of the flexible circuit board has a light-emitting lateral surface. The reflective layer is disposed on a lower surface of the light guiding plate. The light shielding layer is disposed between the flexible circuit board and the reflective layer and surrounds the whole light-emitting lateral surface. At least a portion of the light-emitting lateral surface is higher than a top surface of the reflective layer, at least a portion of the light-emitting lateral surface is opposite to the light-incident lateral surface, a first light emitted by the light-emitting lateral surface enter the light guiding plate from the light-incident lateral surface, a first portion of the first light is reflected by the reflective layer back to the light guiding plate when the first portion of the first light escapes from the lower surface of the light guiding plate, and a second portion of the first light is absorbed by the light shielding layer when the second portion of the first light escapes from the lower surface of the light guiding plate.

The above and other aspects of the invention will become better understood with regard to the following detailed description of the non-limiting embodiment(s). The following description is made with reference to the accompanying drawings.

### BRIEF DESCRIPTION OF THE DRAWINGS

FIG. 1 illustrates an exploded view of a backlight module according to an embodiment of the invention;

FIG. 2 illustrates a top view of combination of a flexible circuit board and a reflective layer;

FIG. 3 illustrates a cross sectional view of the backlight module of FIG. 2 along a direction 3-3′;

FIG. 4 illustrates a cross sectional view of the light-emitting keyboard according to another embodiment of the invention;

FIG. 5 illustrates a cross sectional view of the backlight module of FIG. 2 along a direction 5-5′;

FIG. 6A illustrates a top view (not shows a reflective film) of a backlight module according to another embodiment of the invention;

FIG. 6B illustrates a cross sectional view of the backlight module of FIG. 6A along a direction 6B-6B′; and

FIGS. 7A to 7E illustrate the assembling processes of the backlight module of FIG. 1.

In the following detailed description, for purposes of explanation, numerous details are set forth in order to provide a thorough understanding of the disclosed embodiments. It will be clear, that one or more embodiments may be practiced without these details. In other instances, well-known structures and devices are schematically shown in order to simplify the drawing.

### DETAILED DESCRIPTION

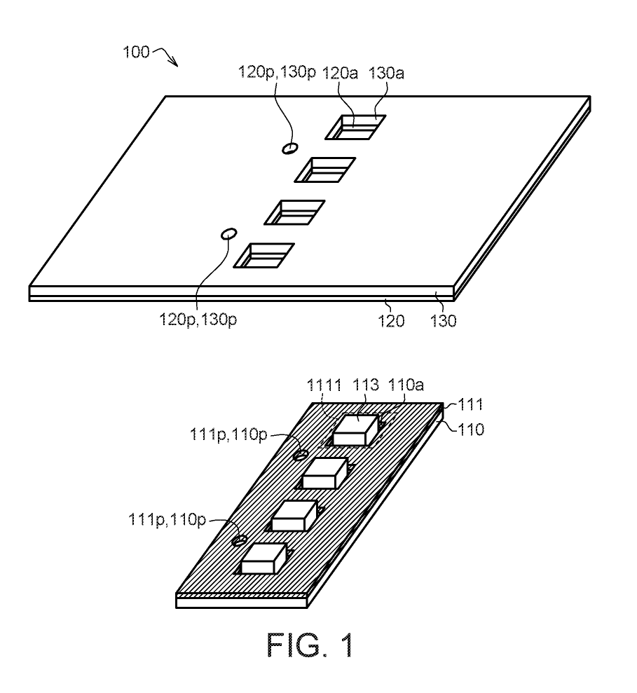

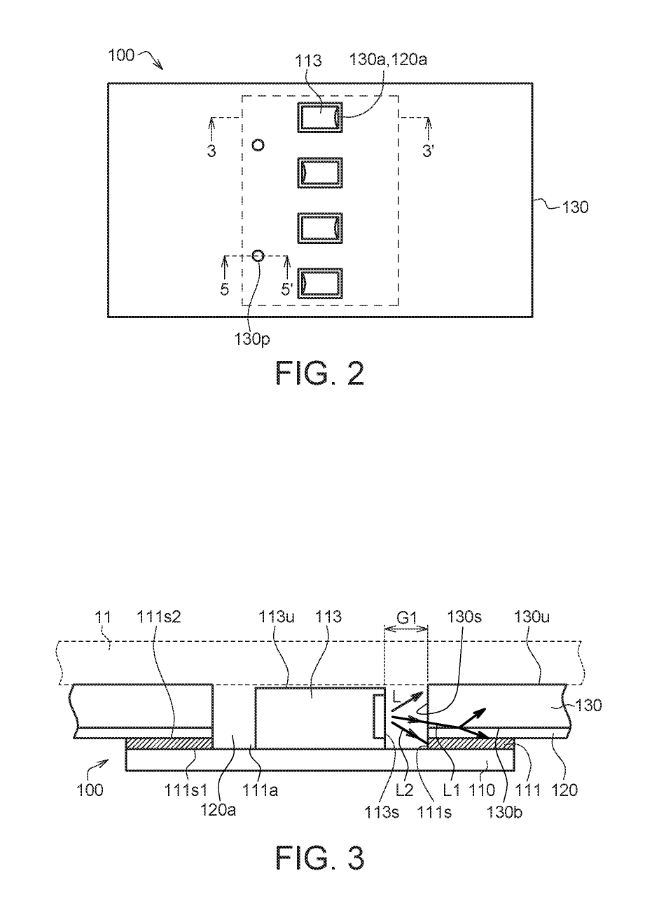

FIG. 1 illustrates an exploded view of a backlight module 100 according to an embodiment of the invention, and FIG. 2 illustrates a top view of combination of a flexible circuit board 110 and a reflective layer 120.

As shown in FIGS. 1 and 2, the backlight module 100 includes a flexible circuit board 110, a reflective layer 120, a light shielding layer 111, a plurality of light-emitting components 113 and a light guiding plate 130. The flexible circuit board 110 is substantially disposed on a central region of the light guiding plate 130, or other regions of the light guiding plate 130. The flexible circuit board 110 may be shaped into a rectangle or other shape. The shape of the flexible circuit board 110 is not limited to the embodiments of the invention. In an embodiment, the flexible circuit board 110 may be a known flexible printed circuit in this art.

The light shielding layer 111 is disposed on the flexible circuit board 110 and has a plurality of openings 110a. Each light-emitting component 113 is disposed on the flexible circuit board 110 and located within the corresponding opening 110a. The light-emitting components 113 are, for example, light-emitting diodes or other kind of light-emitting components.

As shown in FIG. 1, the reflective layer 120 has a plurality of through holes 120a, and the light guiding plate 130 has a plurality of through holes 130a, wherein each through hole 120a overlaps the corresponding through hole 130a. As shown in FIG. 2, after the flexible circuit board 110 is combined with the reflective layer 120, each light-emitting component 113 is located the corresponding through hole 120a and through hole 130a and exposed from the corresponding through hole 120a and through hole 130a.

As shown in FIG. 1, the light shielding layer 111 includes a plurality of surrounding portions 1111. Each surrounding portion 1111 surrounds the corresponding light-emitting component 113, and accordingly it can increase the scopes of preventing light from leaking. In the present embodiment, each surrounding portion 1111 surrounds periphery of the whole light-emitting component 113, and accordingly the light shielding layer 111 may full-circumferentially (360 degrees) prevent the light of the light-emitting component 113 from leaking laterally.

In an embodiment, the light shielding layer 111 is a black light shielding layer, and accordingly it can effectively absorb the light L (for example, a first light L1 and a second light L2 as shown in FIG. 3) to reduce or even avoid the leak of light from gaps or connections among the reflective layer 120, the flexible circuit board 110 and the light shielding layer 111.

FIG. 3 illustrates a cross sectional view of the backlight module 100 of FIG. 2 along a direction 3-3′. After the flexible circuit board 110 is combined with the reflective layer 120, the light shielding layer 111 disposed on the flexible circuit board 110 is located between the flexible circuit board 110 and the light guiding plate 130, and the reflective layer 120 is located between the light guiding plate 130 and the light shielding layer 111. Since the light shielding layer 111 is located between the reflective layer 120 and the flexible circuit board 110, it can reduce or even avoid the leak of light from gaps or connections among the reflective layer 120, the flexible circuit board 110 and the light shielding layer 111. As a result, it can increase the strength of emitting-light of the backlight module 100.

In the present embodiment, the light shielding layer 111 has a first surface 111s1 and a second surface 111s2 opposite to the first surface 111s1, wherein the first surface 111s1 and the second surface 111s2 directly contact the flexible circuit board 110 and the reflective layer 120 respectively, such that there is no gap between the first surface 111 s1 and the flexible circuit board 110, and there is no gap between the second surface 111s2 and the reflective layer 120. As a result, it can reduce or even avoid the leak of light.

As shown in FIG. 3, the light guiding plate 130 has a light-emitting upper surface 130u, and the light guiding plate 130 may guide the light L of the light-emitting component 113 to be emitted out of the light-emitting upper surface 130u.

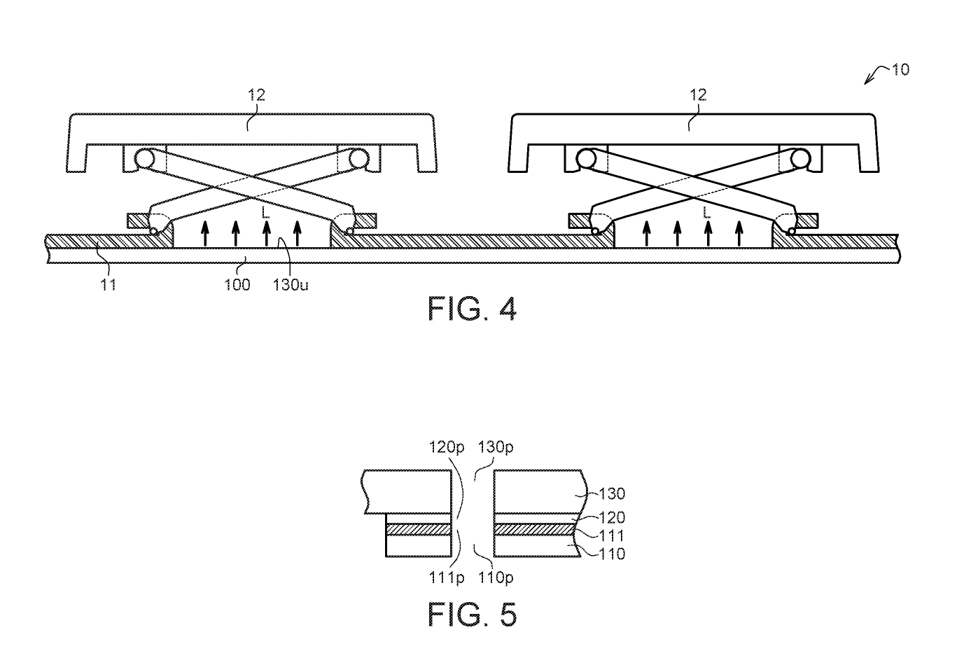

FIG. 4 illustrates a cross sectional view of the light-emitting keyboard 10 according to another embodiment of the invention. The light-emitting keyboard 10 includes the backlight module 100, a bottom plate 11 and a plurality of keys 12, wherein the keys 12 are disposed on the bottom plate 11, and the backlight module 100 is disposed under the bottom plate 11. The light L emitted from the light-emitting upper surface 130u of the light guiding plate 130 may be emitted toward the keys 12.

As shown in FIG. 3, each light-emitting component 113 has a top surface 113u. The light shielding layer 111 may boost the light guiding plate 130, such that the top surface 113u of the light-emitting component 113 is not higher than the light-emitting upper surface 130u of the light guiding plate 130. As a result, after the light-emitting keyboard 10 is assembled to the backlight module 100 (As shown in FIG. 4), the bottom plate 11 of the light-emitting keyboard 10 does not crush the top surface 113u of the light-emitting component 113, and accordingly it can prevent the light-emitting component 113 from being broken by the bottom plate 11.

As shown in FIG. 3, each light-emitting component 113 has a light-emitting lateral surface 113s. The light-emitting lateral surface 113s is spaced from an inner surface 111s3 of the light shielding layer 111 by an interval G1, such that the light emitted from the light-emitting lateral surface 113s may be expanded through the interval G1 and then uniformly enter a light-incident lateral surface 130s of the light guiding plate 130 (that is, it can prevent the light from locally and concentratively being incident to the light-incident lateral surface 130s of the light guiding plate 130).

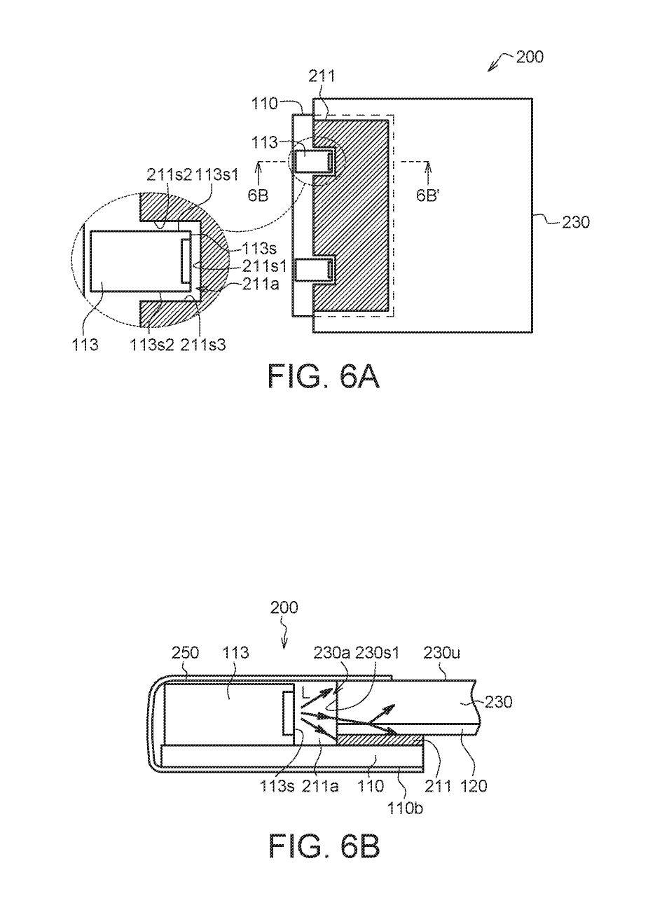

FIG. 5 illustrates a cross sectional view of the backlight module 100 of FIG. 2 along a direction 5-5′. The flexible circuit board 110 has a first aligning hole 110p, and the light shielding layer 111 has a second aligning hole 111p, wherein a position of the first aligning hole 110p is corresponding to a position of the second aligning hole 111p, that is, the first aligning hole 110p overlaps the second aligning hole 111p. In addition, the light guiding plate 130 has a third aligning hole 130p, and the reflective layer 120 has a fourth aligning hole 120p, wherein a position of the third aligning hole 130p is corresponding to a position of the fourth aligning hole 120p, that is, the third aligning hole 130p overlaps the fourth aligning hole 120p. In the present embodiment, the first aligning hole 110p, the second aligning hole 111p, the third aligning hole 130p and the fourth aligning hole 120p are corresponding to one another in position. As a result, in process of assembling, the same aligning pin 21 (shown in FIG. 6E) may pass through the first aligning hole 110p, the second aligning hole 111p, the third aligning hole 130p and the fourth aligning hole 120p to combine the flexible circuit board 110, the reflective layer 120 and the light guiding plate 130.

As shown in FIGS. 1-3, the light guiding plate 130 has a plurality of the through holes 130a, and the light-emitting components 113 are disposed within the through holes 130a; however, such exemplification is not meant to be for limiting. In another embodiment, the through holes 130a may be omitted as long as the light-emitting lateral surface 113s of the light-emitting component 113 is disposed opposite to the light-entering lateral surface 130s of the light guiding plate 130, at least one portion of the light-emitting lateral surface 113s is opposite to the light-entering lateral surface 130s or be positioned in the same height position with the light-entering lateral surface 130s, or at least one portion of the light-emitting lateral surface 113s is higher than a top surface 120s1 of the reflective layer 120. The light shielding layer 111 may merely surround the light-emitting lateral surface 113s of the light-emitting component 113 but not surround the whole light-emitting component 113; under the circumstances, it can reduce the lateral leak of light from the light-emitting component 113 and increase the strength of emitting-light of the backlight module 100.

As shown in FIG. 3, the reflective layer 120 is disposed on the lower surface 130b of the light guiding plate 130, the light shielding layer 111 is disposed between the flexible circuit board 110 and the reflective layer 120, and the light shielding layer 111 surrounds the light-emitting lateral surface 113s. Due to the height relationship of the light-emitting lateral surface 113s, the reflective layer 120 and the light-entering lateral surface 130s, after the first light L1 emitted from the light-emitting lateral surface 113s is incident to the light-entering lateral surface 130s and enters the light guiding plate 130, if the first light L1 escapes from the lower surface 130b of the light guiding plate 130, the first light L1 may be reflected by the reflective layer 120 and then reflected back the light guiding plate 130. Even if the second light L2 emitted from the light-emitting lateral surface 113s does not be incident to the light guiding plate 130, the second light L2 also may be absorbed by the light shielding layer 111, and accordingly it can reduce the lateral leak of light from the light-emitting component 113 and increase the strength of the emitting-light of the backlight module 100.

In addition, due to the structures as mentioned above, even if the first light L1 emitted from the light-emitting lateral surface 113s and entering the light guiding plate 130 escapes from the lower surface 130b of the light guiding plate 130 and thus is not reflected by the reflective layer 120, the first light L1 also may be absorbed by the light shielding layer 111. That is, after the first light L1 emitted from the light-emitting lateral surface 113s is incident to the light-entering lateral surface 130s and enters the light guiding plate 130, if the first light L1 escapes from the lower surface 130b of the light guiding plate 130, a portion of the first light L1 will be reflected by the reflective layer 120 and reflected back the light guiding plate 130, and another portion of the first light L1 will be absorbed by the light shielding layer 111. As a result, it can reduce the lateral leak of light from the light-emitting component 113 and increase the strength of emitting-light of the backlight module 100. In addition, in the present embodiment, the light shielding layer 111 may be a black light shielding layer, an adhesive or a double-sided adhesive.

FIG. 6A illustrates a top view (not shows a reflective film 250) of a backlight module 200 according to another embodiment of the invention, and FIG. 6B illustrates a cross sectional view of the backlight module 200 of FIG. 6A along a direction 6B-6B′.

The backlight module 200 includes the flexible circuit board 110, the reflective layer 120, a light shielding layer 211, a plurality of the light-emitting components 113, a light guiding plate 230 and a reflective film 250.

In the present embodiment, the flexible circuit board 110 is located at one side of the light guiding plate 230. Each light-emitting component 113 has the light-emitting lateral surface 113s and other lateral surfaces, wherein the light shielding layer 211 surrounds the light-emitting lateral surface 113s of each light-emitting component 113 and a portion of other lateral surfaces, and accordingly it can reduce or avoid lateral leak of light.

For example, the light shielding layer 211 has a plurality of recesses 211a, and each light-emitting component 113 is located within the corresponding recess 211a. The recess 211a has a first lateral surface 211s1, a second lateral surface 211s2 and a third lateral surface 211s3 opposite to the second lateral surface 211s2, wherein the first lateral surface 211s1 is located between the second lateral surface 211s2 and the third lateral surface 211s3. Each light-emitting component 113 has the light-emitting lateral surface 113s, a fourth lateral surface 113s1 and a fifth lateral surface 113s2 opposite to the fourth lateral surface 113s1, wherein the light-emitting lateral surface 113s is located between the fourth lateral surface 113s1 and the fifth lateral surface 113s2. The first lateral surface 211s1 of the recess 211a faces the light-emitting lateral surface 113s of the light-emitting component 113, the second lateral surface 211s2 of the recess 211a faces at least one portion of the fourth lateral surface 113s1 of the light-emitting component 113, and the third lateral surface 211s3 of the recess 211a faces at least one portion of the fifth lateral surface 113s2 of the light-emitting component 113. Due to the lateral surfaces of the recess 211a covers the light-emitting lateral surface 113s and at least one portion of two lateral surfaces (for example, the fourth lateral surface 113s1 and the fifth lateral surface 113s2) in two sides of the light-emitting lateral surface 113s, it can avoid or reduce the leak of the light.

In addition, the light guiding plate 230 has a plurality of recesses 230a. The corresponding relationship of the recesses 230a and the light-emitting components 113 is similar to the corresponding relationship of the recesses 211a and the light-emitting components 113, and the similarities are not repeated here.

As described above, as long as the light shielding layer 211 surrounds the light-emitting lateral surface 113s, the embodiment of the present invention of the light shielding layer 211 is not limited to surrounding all lateral surfaces of the light-emitting component 113.

In addition, as shown in FIG. 6B, the reflective film 250 may encapsulate the light-emitting components 113. For example, one side of the reflective film 250 may adhere to the light-emitting upper surface 230u of the light guiding plate 230, and another side of the reflective film 250 may adhere to the lower surface 110b of the flexible circuit board 110. The reflective film 250 may be bent into a U-shaped reflective film, wherein the light-emitting components 113 may be encapsulated between two sides of the reflective film 250. The reflective film 250 may reflect the light of the light-emitting components 113 back the light guiding plate 230 or the light shielding layer 211, and accordingly it can reduce or avoid the leak of the light.

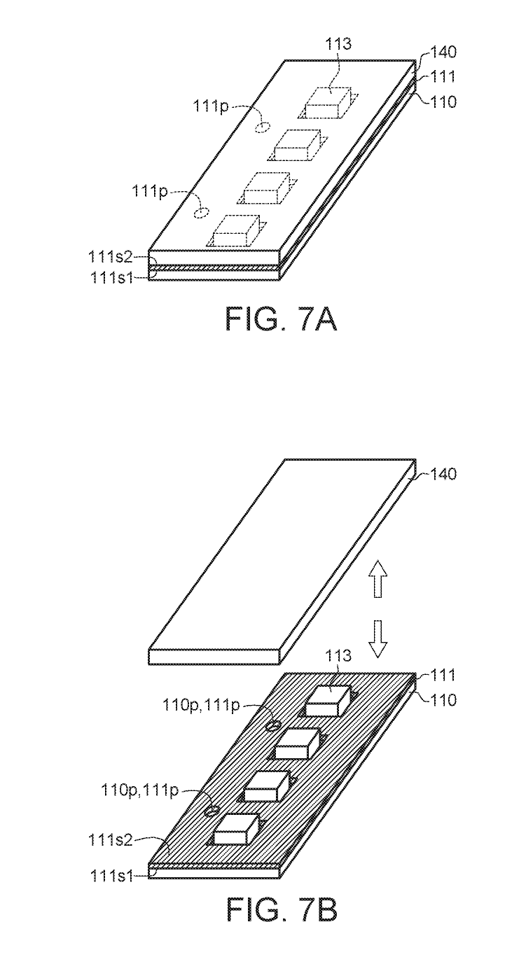

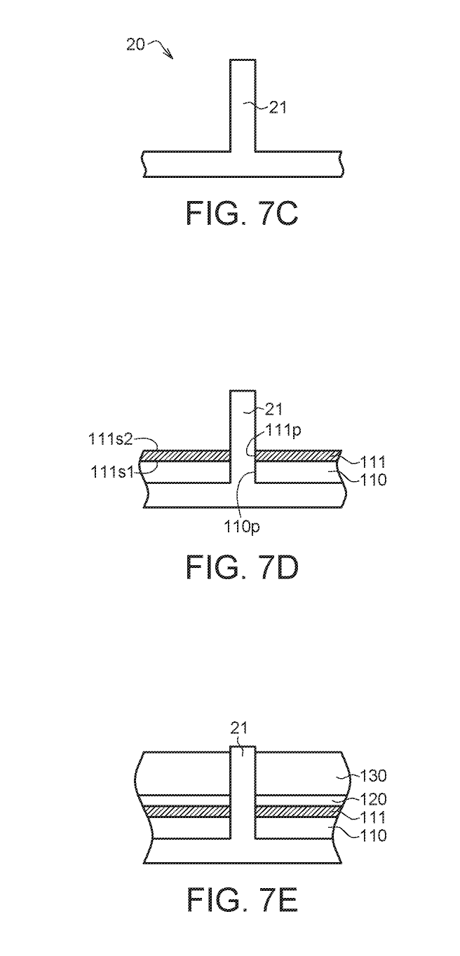

FIGS. 7A to 7E illustrate the assembling processes of the backlight module 100 of FIG. 1.

As shown in FIG. 7A, the flexible circuit board 110 and a release film 140 are provided. In the present embodiment, the light shielding layer 111 of the flexible circuit board 110 is a double-sided adhesive, that is, the first surface 111s1 and the second surface 111s2 of the light shielding layer 111 are adhesive surfaces, wherein the first surface 111s1 is adhered to the flexible circuit board 110. The release film 140 is adhered to and covers the second surface 111 s2 of the light shielding layer 111 for preventing the second surface 111s2 from being polluted, and thus the adhesion of the second surface 111s2 is reduced.

As shown in FIG. 7B, the release film 140 and the light shielding layer 111 are separated to expose the second surface 111s2 of the light shielding layer 111 and the second aligning hole 111p of the light shielding layer 111.

As shown in FIG. 7C, an assembling jig 20 is provided, wherein the assembling jig 20 includes an aligning pin 21.

As shown in FIG. 7D, the flexible circuit board 110 and the light shielding layer 111 are placed on the assembling jig 20 by way of the first aligning hole 110p and the second aligning hole 111p aligning with the aligning pin 21, wherein the second surface 111s2 of the light shielding layer 111 face outward for conveniently adhering to the reflective layer 120 in subsequent assembling process.

As shown in FIG. 7E, the reflective layer 120 and the light guiding plate 130 are placed on the second surface 111s2 of the light shielding layer 111 by way of the third aligning hole 130p and the fourth aligning hole 120p aligning with the same aligning pin 21, such that the reflective layer 120 adheres to the second surface 111s2. As a result, the assembling of the flexible circuit board 110, the reflective layer 120 and the light guiding plate 130 is completed.

In addition, the assembling method of the backlight module 200 is similar to that backlight module 100, and the similarities are not repeated here.

It will be clear that various modifications and variations can be made to the disclosed embodiments. It is intended that the specification and examples be considered as exemplary only, with a true scope of the invention being indicated by the following claims and their equivalents.

What is claimed is:

1. A backlight module of a keyboard, comprising:
a flexible circuit board;
a light-emitting component disposed on the flexible circuit board;
a light shielding layer disposed on the flexible circuit board and surrounding the whole light-emitting component; and
a light guiding plate having a through hole within which the light-emitting component is disposed;
wherein the light shielding layer is located between the flexible circuit board and the light guiding plate.

2. The backlight module according to claim 1, wherein the light shielding layer is a black light shielding layer.

3. The backlight module according to claim 1, wherein the flexible circuit board has a first aligning hole, and the light shielding layer has a second aligning hole, wherein the first aligning hole is corresponding to the second aligning hole in position.

4. The backlight module according to claim 1, wherein the light shielding layer is an adhesive.

5. The backlight module according to claim 1, wherein the light shielding layer is a double-sided adhesive.

6. The backlight module according to claim 1, wherein the light-emitting component has a light-emitting lateral surface, the light shielding layer has an inner surface, and the light-emitting lateral surface is spaced from the inner surface by an interval.

7. The backlight module according to claim 1, comprising a plurality of the light-emitting components, wherein the light shielding layer comprises a plurality of surrounding portions, and each surrounding portion surrounds the corresponding light-emitting component.

8. The backlight module according to claim 1, wherein the light shielding layer has a first adhesive surface and a second adhesive surface opposite to the first adhesive surface, the first adhesive surface is adhered to the flexible circuit board, and the flexible circuit board further comprises:
a release film covering the second adhesive surface.

9. The backlight module according to claim 1, further comprises:
a reflective layer disposed between the light guiding plate and the flexible circuit board.

10. The backlight module according to claim 9, wherein two opposite surfaces of the light shielding layer directly contact the flexible circuit board and the reflective layer respectively.

11. The backlight module according to claim 1, wherein the flexible circuit board has a first aligning hole, the light shielding layer has a second aligning hole, and the light guiding plate has a third aligning hole, wherein the first aligning hole, the second aligning hole and the third aligning hole are corresponding to one another in position.

12. The backlight module according to claim 1, wherein the light guiding plate has a light-emitting upper surface, the light-emitting component has a top surface, and the top surface is not higher than the light-emitting upper surface.

13. A light-emitting keyboard, comprising:
a bottom plate;
a plurality of keys disposed on the bottom plate; and
the backlight module according to claim 1 disposed under the bottom plate.

14. A backlight module, comprising:
a flexible circuit board;
a light-emitting component disposed on an upper surface of the flexible circuit board having a light-emitting lateral surface;
a light guiding plate disposed on the flexible circuit board and having a light-incident lateral surface;
a reflective layer disposed on a lower surface of the light guiding plate; and
a light shielding layer disposed between the flexible circuit board and the reflective layer and surrounding the whole light-emitting lateral surface;
wherein at least a portion of the light-emitting lateral surface is higher than a top surface of the reflective layer, at least a portion of the light-emitting lateral surface is opposite to the light-incident lateral surface, a first light emitted by the light-emitting lateral surface enters the light guiding plate from the light-incident lateral surface, the first light is reflected by the reflective layer back to the light guiding plate when the first light escapes from the lower surface of the light guiding plate, and a second light emitted by the light-emitting lateral surface which does not enter the light guiding plate is absorbed by the light shielding layer.

15. The backlight module according to claim 14, wherein the light shielding layer is a black light shielding layer, an adhesive or a double-sided adhesive.

16. The backlight module according to claim 14, wherein the flexible circuit board has a first aligning hole, and the light shielding layer has a second aligning hole, wherein the first aligning hole is corresponding to the second aligning hole in position.

17. The backlight module according to claim 14, comprising a plurality of the light-emitting components, wherein the backlight module comprises a plurality of light-emitting lateral surfaces, the light shielding layer comprises a plurality of surrounding portions, and each surrounding portion surrounds the corresponding light-emitting lateral surface.

18. The backlight module according to claim 14, wherein the light guiding plate has a light-emitting upper surface, the light-emitting component has a top surface, and the top surface is not higher than the light-emitting upper surface.

19. A backlight module, comprising:
a flexible circuit board;
a light-emitting component disposed on an upper surface of the flexible circuit board having a light-emitting lateral surface;
a light guiding plate disposed on the flexible circuit board and having a light-incident lateral surface;
a reflective layer disposed on a lower surface of the light guiding plate; and
a light shielding layer disposed between the flexible circuit board and the reflective layer and surrounding the whole light-emitting lateral surface;
wherein at least a portion of the light-emitting lateral surface is higher than a top surface of the reflective layer, at least a portion of the light-emitting lateral surface is opposite to the light-incident lateral surface, a first light emitted by the light-emitting lateral surface enter the light guiding plate from the light-incident lateral surface, a first portion of the first light is reflected by the reflective layer back to the light guiding plate when the first portion of the first light escapes from the lower surface of the light guiding plate, and a second portion of the first light is absorbed by the light shielding layer when the second portion of the first light escapes from the lower surface of the light guiding plate.

20. The backlight module according to claim 19, wherein the light shielding layer is a black light shielding layer, an adhesive or a double-sided adhesive.

21. The backlight module according to claim 19, wherein the flexible circuit board has a first aligning hole, and the light shielding layer has a second aligning hole, wherein the first aligning hole is corresponding to the second aligning hole in position.

22. The backlight module according to claim 19, comprising a plurality of the light-emitting components, wherein the backlight module comprises a plurality of light-emitting lateral surfaces, the light shielding layer comprises a plurality of surrounding portions, and each surrounding portion surrounds the corresponding light-emitting lateral surface.

23. The backlight module according to claim 19, wherein the light guiding plate has a light-emitting upper surface, the light-emitting component has a top surface, and the top surface is not higher than the light-emitting upper surface.
